(19) United States
(12) Patent Application Publication
(10) Pub. No.: US 2002/0003315 A1
(43) Pub. Date: Jan. 10, 2002

(54) Method and device to control polymerization

(76) Inventor: Madhu Ayyagari, Fairport, NY (US)

Correspondence Address: Katherine McGuire, Bausch & Lomb Incorporated, One Bausch & Lomb Place, Rochester, NY, 14604-2701, US

(21) Appl. No.: 09/783,433

(22) Filed: Feb. 14, 2001

Related U.S. Application Data
(60) Provisional application No. 60/193,822, filed on Mar. 31, 2000.

(51) Int. Cl. B29D 11/00

(52) U.S. Cl. 264/1.36; 264/1.38

(57) ABSTRACT

A method and mold assembly to control the polymerization of a molded article. In one embodiment, radiation is delivered to the mold assembly in a controlled manner by fiber optics. In an alternate embodiment, a diffuser attached to a fiber optics bundle serves as a molding surface. This allows the polymerizable material between the diffuser and mold portion to be uniformly cured.

### BACKGROUND OF THE INVENTION

The present invention is directed toward controlled curing of devices requiring optical cure using fiber optics. More specifically, the present invention provides a method for curing optical devices such that the devices undergo a more controlled polymerization, resulting in a reduction in defects such as dimpling and warpage in the cured device. In particular, the optical devices include ophthalmic lenses including contact lenses, intraocular lenses, spectacle lenses, corneal onlays and corneal inlays. More particularly, this method provides for a method to produce contact lenses having a controlled cure profile.

It is often desirable to mold optical devices such as contact lenses and intraocular lenses, rather than form the lenses by machining operations. In general, molded lenses are formed by depositing a curable liquid such as a polymerizable monomer into a mold cavity, curing the liquid into a solid state, opening the mold cavity and removing the lens. In particular, the mold cavity may be formed by a mold assembly comprised of a posterior mold portion and an anterior mold portion, each having a lens-forming surface. When the posterior mold portion and anterior mold portion are mated, the lens-forming surface of the posterior mold portion and the lens-forming surface of the anterior mold portion form the lens-forming cavity. The non-lens-forming surface of both mold portions, herein referred to as non-critical surfaces, are generally molded to have a similar radius (or radii) of curvature as that of the lens-forming surfaces. While the lens-forming surfaces are of optical quality, each having a central optical zone and a peripheral carrier zone, the only requirement of the non-critical surface generally is a smooth surface.

A common material used as a mold material is polypropylene, which is disclosed in U.S. Pat. No. 5,271,875 (Appleton et al., assigned to Bausch & Lomb Incorporated, the entire contents herein incorporated by reference). The process disclosed in Appleton et al., may be used to produce lenses with predictable and repeatable characteristics.

The use of polypropylene may be desired with certain lens-forming materials. Other lens-forming materials, however, may cast just as well or better in other mold materials. As disclosed in U.S. Ser. No. 09/312105 (Ruscio et al. and assigned to Bausch & Lomb Incorporated, the entire contents herein incorporated by reference), polyvinyl chloride absent any UV stabilizer provides a suitable material for the posterior mold.

Polymerization is typically carried out by thermal means, irradiation or combinations thereof. Traditionally, conventional thermo-casting techniques require fairly long curing times and are used when the resultant object is thick. Rods from which rigid gas permeable lenses are lathed from or thicker lenses are often thermally cured. Curing of lenses by irradiation, in particular, ultraviolet (UV) irradiation, frequently offers short curing times. The monomer is poured into a transparent mold having a desired optical surface, and thereafter the UV light is radiated to the monomer through the transparent mold to cure the photosetting monomer.

While the radiation of the optical device from the light source may be conducted in a uniform and parallel manner, the material chosen for the mold portions may affect the pathways of the light rays. For instance, some materials, such as thermoplastic crystalline polymers, may diffuse the radiation, causing a scattering of the light rays. Polypropylene is such a material. Other materials such as polyvinyl chloride and polystyrene are thermoplastic amorphous polymers, which permit an unhindered pathway for the light rays during curing.

The radiation may also be reflected off the surface of the glass or plastic mold materials. This may result in non-uniform distribution of light intensity over the lens-forming material.

The placement of the optical source may influence the cure. Typically, a bank of lamps supply the radiation necessary for curing the molded article. The lamps may be setup in a circular or linear assembly and the mold assemblies containing the polymerizable material are passed under the lamps. Each individual mold assembly may be exposed to a different amount of radiation as they pass under the lamp array. Additionally, heat generated from the lamps may affect the lens curing profile.

A problem seen with curing multiple mold assemblies involves controlled exposure to radiation. Typically, banks of lamps are setup in circular or linear assembly with the mold assemblies passing beneath the lamps. Each mold assembly may not be exposed to the identical amounts of light, resulting in uncontrolled or irregular cure profiles of the resultant cured article. Additionally, an assembly closer to the lamps may be exposed to more heat, which may affect the curing process.

Non-uniform curing of the polymerization material may cause problems with the molded article. For example, since the curing is completed faster and more completely in a portion receiving a high radiation intensity (in this instance, the periphery portion of the lens) and slower in a portion receiving a low radiation intensity (the central portion, respectively), a stress is generated in the cured resin layer. This stress deteriorates the precision of the optical device face. Additionally, since the faster curable portion receiving higher radiation intensity is cured with absorption of the surrounding uncured resin in order to compensate for the contraction of resin resulting from curing, the slower curable portion (which receives lower radiation intensity) shows defects such as shrinkage. In particular, in the case of contact lenses and spectacle lenses, this can produce lenses with unacceptable optical aberrations caused by uneven curing and stress. “Dimpling” or warpage of the contact lens is a common problem caused by uneven curing. In dimpling, the apex of the lens is flattened or slightly concave in shape. Warpage is generally seen as the inability of the edge of a lens to have continuous contact with the molding surface upon which it contacts. Other drawbacks seen with plastic spectacle lenses include “striations”, which are caused by uneven curing and stress. Thermal gradients form in the gel-state, which produce convection lines (“striations”) that become frozen in place and cannot be dispersed.

Numerous patents disclose methods for overcoming non-uniform polymeriztion problems (see for example, U.S. Pat. Nos. 4,166,088; 4,534,915; 4,879,318; 4,919,850; 4,988,274; 5,135,685; 5,269,867; and 5,529,728).

Fiber optics allow for the transmission of light through fibers or thin rods of ultra pure glass or some other transparent material of high refractive index. The fibers have an outer layer called cladding and form the center of a fiber optic cable. The cable is enclosed in a protective sheath. Light traveling inside the fiber strikes the outside surface at an angle of incidence greater than the critical angle so that all the light is reflected toward the inside of the fiber without loss. Laser light is one example of a light that can be transmitted by optical fibers.

U.S. Pat. No. 5,914,074 (Martin et al.) discloses generating polymerization radiation remotely and routing it to the mold via a fiber optic system. More>>>>

None of the above art completely solves the problems of inconsistency which occur when using a bank of lamps to affect cure of a polymerizable material contained within a mold assembly. The resultant lenses made from this particular molding method may have defects such as dimpling and warpage.

### SUMMARY OF THE INVENTION

The present invention is a method for photocuring cast articles such as ophthalmic lenses in which defects in the cured article are reduced. By controlling the pathway of radiation, defects can be reduced. By controlling the relative intensity of radiation upon a particular portion of lens-forming material, the rate of polymerization taking place at various portions of the lens can be controlled.

In the preferred embodiment, the light pathway can be guided through a bundle of optical fibers. The optical fibers can direct the light to the posterior mold or may end with a diffuser which can replace the posterior mold. The light is distributed across the non-critical surface of the posterior mold such that an even distribution is achieved.

This distribution reduces the inconsistent cure gradient across the lens, which removes any residual stress induced during curing. The result is a cured article such as a contact lens having an acceptable apex in the central portion of the lens. Fiber optics allows control of the illumination intensity profile reaching various sections of the contact lens. Stress developed by uneven intensity profiles can be removed or introduced.

The ophthalmic lenses formed from these methods are relatively free from defects such as dimpling and warpage.

### BRIEF DESCRIPTION OF THE DRAWINGS

FIG. 1 is a cross-sectional elevational view of a posterior mold section assembled with an anterior mold section;

FIG. 2 is a perspective exploded view of a mold assembly including a contact lens;

FIG. 3 is a cross-sectional elevational view of a posterior mold section showing radiation diffusion through the mold section;

FIG. 4 is a cross-sectional elevational view of a mold assembly, radiation supplied through an optical fiber bundle; and

FIG. 5 is a cross-sectional elevational view of a mold assembly with a diffuser as the posterior mold section, radiation is supplied through an optical fiber bundle.

### DETAILED DESCRIPTION OF THE INVENTION

The present invention is useful for the method of making ophthalmic lenses. Preferred embodiments include the method of making intraocular and contact lenses.

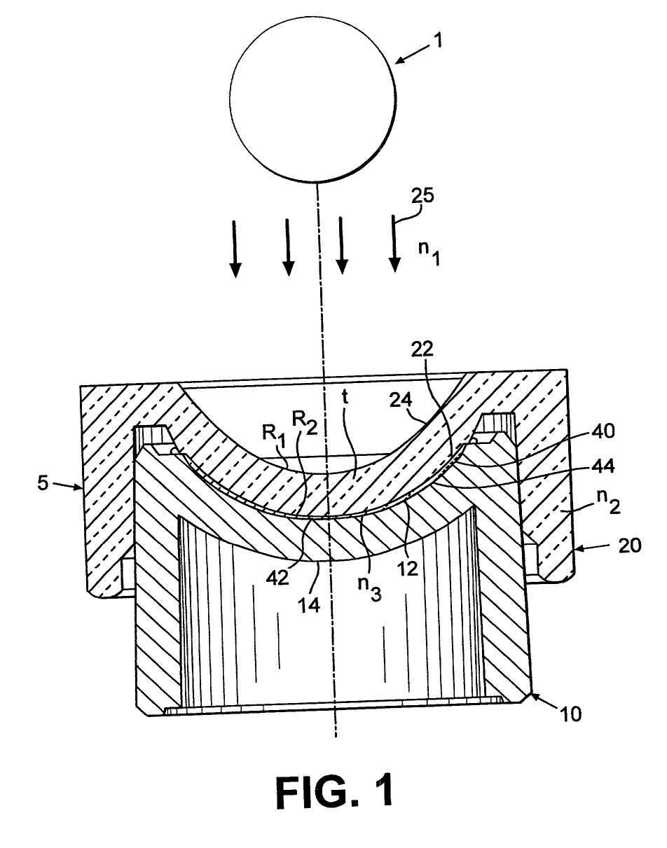

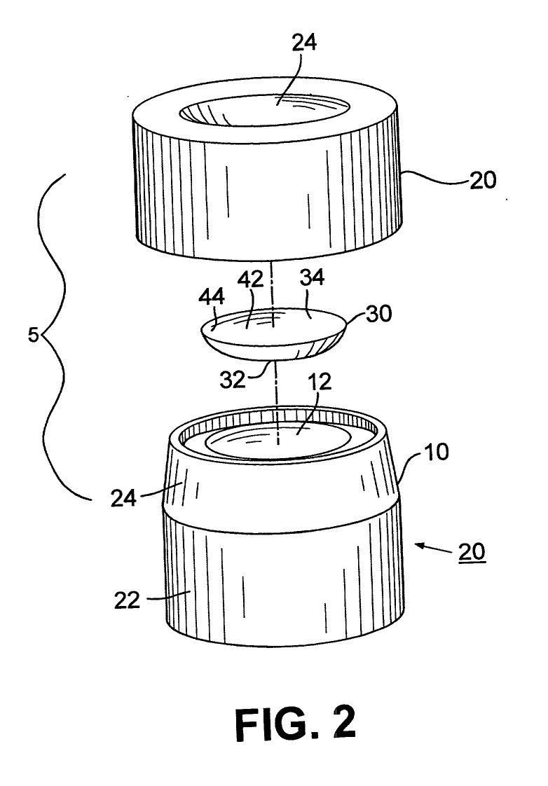

As seen in FIGS. 1 and 2, mold assembly 5 defines mold cavity 40 for casting lens 30, including anterior mold portion 10 for defining the anterior lens surface 32 and posterior mold portion 20 for defining the posterior lens surface 34. Anterior mold 10 has lens-forming surface (critical surface) 12 and non-critical surface 14. Posterior mold 20 has lens forming surface 22 and non-critical surface 24. When posterior mold section 20 is assembled with an anterior mold section 10, lens-forming cavity 40 is formed between posterior mold section lens forming surface 22 and anterior mold section lens-forming surface 12. As discussed in Appleton et. al., lens 30 formed from this mold assembly include a central optical zone 42 and a peripheral carrier zone 44. The peripheral zone 44 has a substantially greater volume than the optical zone 42 and may include a tapered edge.

Any known material used in the manufacturing of contact lenses may be used. In particular, the preferred material for posterior mold portion 20 is a crystalline material such as polypropylene or an amorphous material such as polyvinyl chloride (PVC) or polystyrene. Other suitable materials include an amorphous copolymer of ethylene and a cyclic olefin (such as a resin available under the tradename of Topas, from Hoechst Celanese Corporation), standard glasses, synthetic polymers with glass-like properties such as polymethyl methacrylate, polycarbonate, acrylonitrile copolymer (such as resin available under the tradename of Barex), TPX (poly-4-methyl 1-pentene) and polyacrylonitrile. Accordingly, it is preferred that anterior mold 10 is amorphous although other crystalline thermoplastic material such as polypropylene may be used The optical or radiation source may be actinic, electron beam, laser or radioactive source, but is preferably ultraviolet lamps which irradiates the monomer. Visible light or infra-red light may also be used. Radiation may also be from a high intensity UV source. Additionally, combinations of light radiation and thermal means may be used. Unless specified, the term “light” or “rays” will refer to any actinic wavelength or range of wavelengths.

The index of refraction of rays 25 changes as the rays pass through air and then through a solid material.

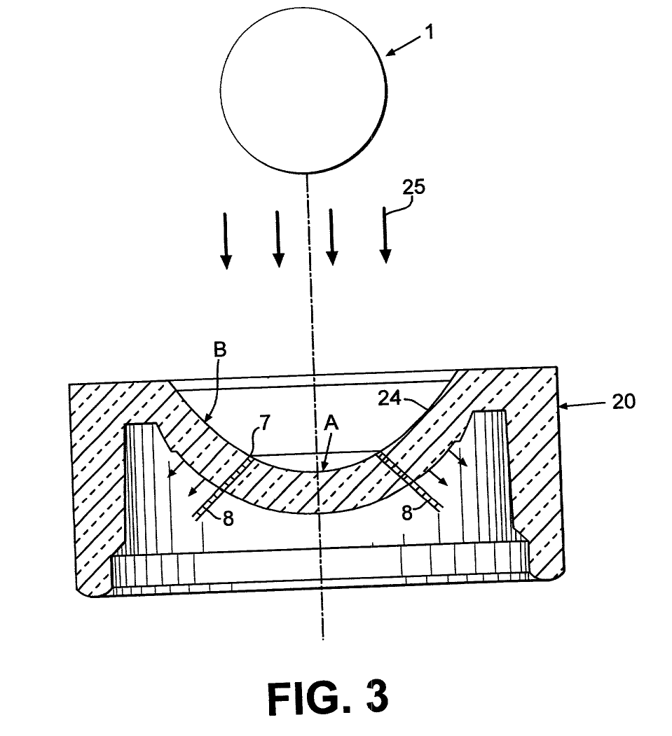

Non-critical surface 24 of posterior mold 20 is typically spherical with a radius of curvature that is concentric with equivalent radii of lens-forming surface 22. This keeps the thickness relatively constant across the posterior mold This concentric requirement forces posterior mold 20, especially when posterior mold 20 is an amorphous material, to be a substantially negative lens. Rays 25 passing through non-critical surface 24 of posterior mold 20 are refracted outward, away from the center optical portion and toward the peripheral carrier zone of the lens being cured. This is illustrated in FIG. 3.

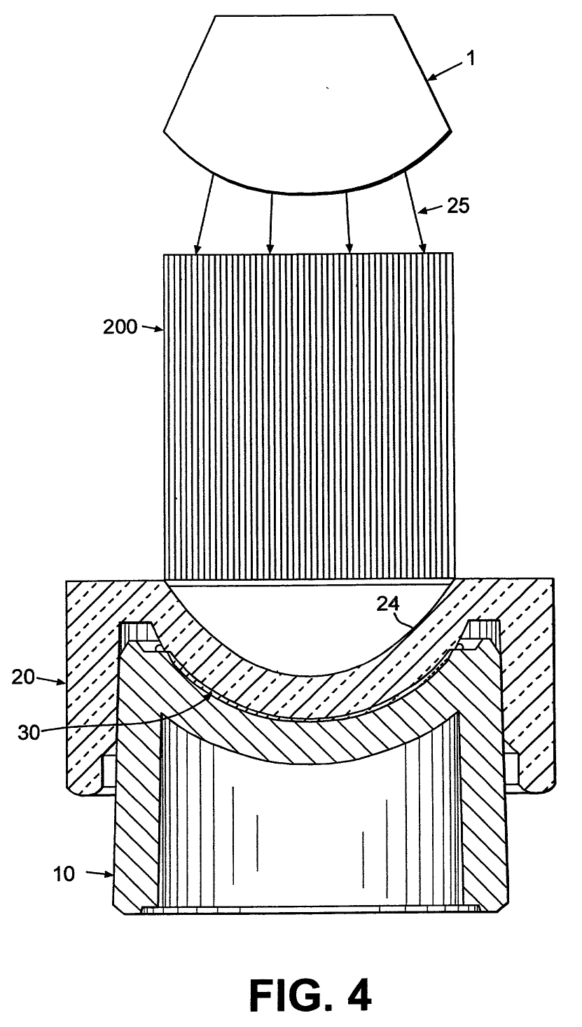

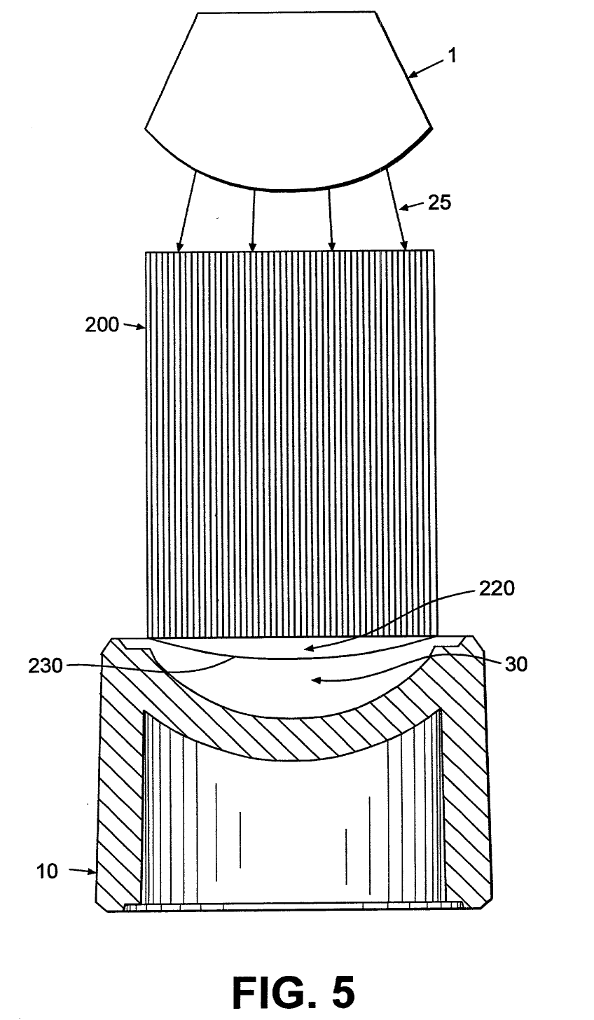

The preferred embodiments are illustrated in FIGS. 4 and 5.

By using optical fibers to deliver radiation, the heat generated near the mold assemblies is minimal and the radiation delivered to the lens-forming material is uniform in intensity.

As shown in FIG. 4, rays 25 from optical source 1 are delivered by optical fiber bundles 200 to posterior mold 20. The optical fiber bundles 200 evenly distribute the rays 25 across non-critical surface 24 of posterior mold 20. The even distribution of radiation cures lens-forming material 30 between posterior mold 20 and anterior mold 10.

In an alternate embodiment shown in FIG. 5, rays 25 from optical source 1 are delivered by optical fiber bundles 200 to diffuser 220 which acts as the posterior mold. Lens-forming surface 230 contacts with lens-forming polymerizable material 30 to form the posterior lens surface (not shown). Lens-forming surface 230 is a critical surface and forms one optical surface of the lens. Diffuser 220 provides a collimated beam of radiation that has uniform intensity across its radial cross-section. Upon curing, radiation is evenly distributed across the diffuser, producing a lens with an even cure profile.

The diffuser can be made from any optically transparent or translucent material.

The diffuser can be attached to the fiber optics bundle by mechanical, chemical or thermal means.

While this method of can be used to cure any ophthalmic lens, it is especially preferred for curing contact lenses. As such, while HEMA (2-hydroxyethylmethacrylate) is a preferred monomer, any lens-forming polymerizable material may be used. Especially preferred are materials that are capable of free radical polymerization. Preferred materials include silicone and methacrylate hydrogels. Preferred examples of applicable materials are disclosed in U.S. Pat. Nos. 5,610,252 and 5,070,215 (Bambury et al., assigned to Bausch & Lomb Incorporated, the entire contents herewith incorporated by reference).

What is claimed is:

1. A method of casting an ophthalmic lens within a mold assembly, said assembly comprised of first and second mold portions, said first mold having first and second surfaces, said first surface comprised of a cavity and said second surface comprising an optical lens-forming surface, said second mold having first and second surfaces, said first surface comprising an optical lens-forming surface, said method comprising the steps of
a) charging said first surface of said second mold portion with a polymerizable monomer;
b) assembling said mold portions such that said polymerizable monomer is sandwiched between said lens-forming surface of said first mold portion and said first surface of said second mold portion;
d) irradiating said mold assembly, said radiation comprised of an optical source and a series of optical fibers, said fibers guiding said radiation from said optical source to said first surface of said first mold portion whereby said monomer is cured to form a molded lens.

2. A method of casting an ophthalmic lens within a mold assembly, said assembly comprised of first and second mold portions, said first mold a first and second mold surface, said first surface capable of being attached to a series of optical fibers and said second mold surface comprising an optical lens-forming surface, said second mold having first and second surfaces, said first surface comprising an optical lens-forming surface, said method comprising the steps of:
a) charging said first surface of said second mold portion with a polymerizable monomer;
b) assembling said mold portions such that said polymerizable monomer is sandwiched between said lens-forming surface of said first mold portion and said first surface of said second mold portion;
c) irradiating said mold assembly, said radiation comprised of an optical source and a series of optical fibers such that said optical fibers attach to said first surface of said first mold, said optical fibers guiding said radiation from said optical source to said first surface of said first mold portion whereby said monomer is cured to form a molded lens.

3. A method of casting an ophthalmic lens within a mold assembly, said assembly comprised of first and second mold portions, said first mold having first and second opposing surfaces, said first surface comprising an optical lens-forming surface, said second mold having first and second opposing surfaces, said first surface comprising an optical lens-forming surface, said method comprising the steps of:
a) charging said first surface of said second mold portion with a polymerizable monomer;
b) assembling said mold portions such that said polymerizable monomer is sandwiched between said lens-forming surface of said first mold portion and said first surface of said second mold portion;
d) irradiating said mold assembly, said radiation comprised of an optical source and a series of optical fibers, said fibers guiding said radiation from said optical source to said second surface of said first mold portion whereby said monomer is cured to form a molded lens.

4. The method of claim 3, wherein said first mold portion is an anterior mold portion.

5. The method of claim 3, wherein said first mold portion is a posterior mold portion.
